(19) United States
(12) Patent Application Publication
(10) Pub. No.: US 2009/0322474 A1
(43) Pub. Date: Dec. 31, 2009

(54) System for turning on and off power using door card key

(76) Inventor: Se Young Park, Seoul (KR)

Correspondence Address: MT-IP LAW, PLLC, 4000 Legato Road, Fairfax, VA, 22033, US

(21) Appl. No.: 12/284,844

(22) Filed: Sep. 25, 2008

(30) Foreign Application Priority Data
Jun. 27, 2008 (KR) 10 2008 0061378

(51) Int. Cl. G06K 19/00

(52) U.S. Cl. 340/5.61

(57) ABSTRACT

Disclosed herein is a system for turning on and off power using a door card key. Transmission means includes a switch unit turned on and off depending on the insertion of the door card key, a switch monitoring unit configured to generate a clock signal, a microcomputer unit configured to generate an RF signal, a transmission signal amplification unit configured to amplify the RF signal generated by the microcomputer unit, and a transmission unit configured to transmit the amplified RF signal. Reception means includes a reception unit configured to receive the RF signal from the transmission means, a reception signal amplification unit configured to amplify the RF signal from the reception unit, a drive signal generation unit configured to convert the RF signal into a drive signal and then output the drive signal, and a control switch unit turned on and off in response to the drive signal.

### BACKGROUND OF THE INVENTION

1. Field of the Invention

The present invention relates to a system for turning on and off power using a door card key.

2. Description of the Related Art

Generally, when a door card key is inserted into a door card key receptacle inside the door, a system for turning on and off power using a door card key performs a switching operation and supplies power to one or more electric devices installed in a predetermined region.

In a prior art system for turning on and off power using a door card key, various electric devices, such as a refrigerator, a television, a microwave oven, an audio player, and an electric light, are connected to electric outlets. The electric outlets are connected to one end of a switch provided in the door card key receptacle, and a power supply device is connected to the other end of the switch.

In the prior art system for turning on and off power using a door card key, when a door card key is inserted into a door card key receptacle, a switch is turned on, thereby electrically connecting a power supply device to one or more electric outlets, and supplying power to the electric devices connected to the respective electric outlets.

However, in the prior art system for turning on and off power using a door card key, since all electric devices are turned on and off depending on whether a door card key is inserted or not, there arises a problem in that electric devices, such as a refrigerator, to which power must always be supplied, are turned on and off based on the entering and leaving of a user.

Further, since all the electric outlets must be connected to a door card key receptacle through electric wires, there is a problem in that it is considerably difficult to construct, maintain, and manage the prior art system for turning on and off power using a door card key.

### SUMMARY OF THE INVENTION

Accordingly, the present invention has been made keeping in mind the above problems occurring in the prior art, and an object of the present invention is to provide a system for turning on and off power using a door card key, which can maintain the state in which one or more electric devices, such as a refrigerator, to which power must be always supplied, are continuously turned on regardless of the entering and leaving of a user even though one or more electric devices are turned on and off depending on whether a door card key is inserted or not.

Another object of the present invention is to provide a system for turning on and off power using a door card key, in which one or more electric outlets are selectively connected to a door card key receptacle by electric wires, thereby easily performing the construction, maintenance, and management thereof.

In order to accomplish the above object, the present invention provides a system for turning on and off power using a door card key depending on the insertion of a door card key into a door card key receptacle inside a door, the system including transmission means which includes a switch unit configured to be turned on and off depending on the insertion of the door card key, a switch monitoring unit configured to generate a clock signal depending on whether the switch unit is turned on or off, a microcomputer unit configured to generate an RF signal based on a previously set address when the clock signal is generated by the switch monitoring unit, a transmission signal amplification unit configured to amplify the RF signal generated by the microcomputer unit, and a transmission unit configured to transmit the RF signal amplified by the transmission signal amplification unit; and reception means which includes a reception unit configured to receive the RF signal from the transmission means, a reception signal amplification unit configured to amplify the RF signal from the reception unit, a drive signal generation unit configured to convert the RF signal, amplified by the reception signal amplification unit, into a drive signal and then output the resulting drive signal, and a control switch unit configured to be turned on and off in response to the drive signal generated by the drive signal generation unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically showing configuration according to an embodiment of the present invention;

FIG. 2 is a circuit diagram showing the configuration of transmission means according to the embodiment of the present invention in detail; and

FIG. 3 is a circuit diagram showing the configuration of reception means according to the embodiment of the present invention in detail.

### DESCRIPTION OF THE PREFERRED EMBODIMENTS

Reference now should be made to the drawings, in which the same reference numerals are used throughout the different drawings to designate the same or similar components.

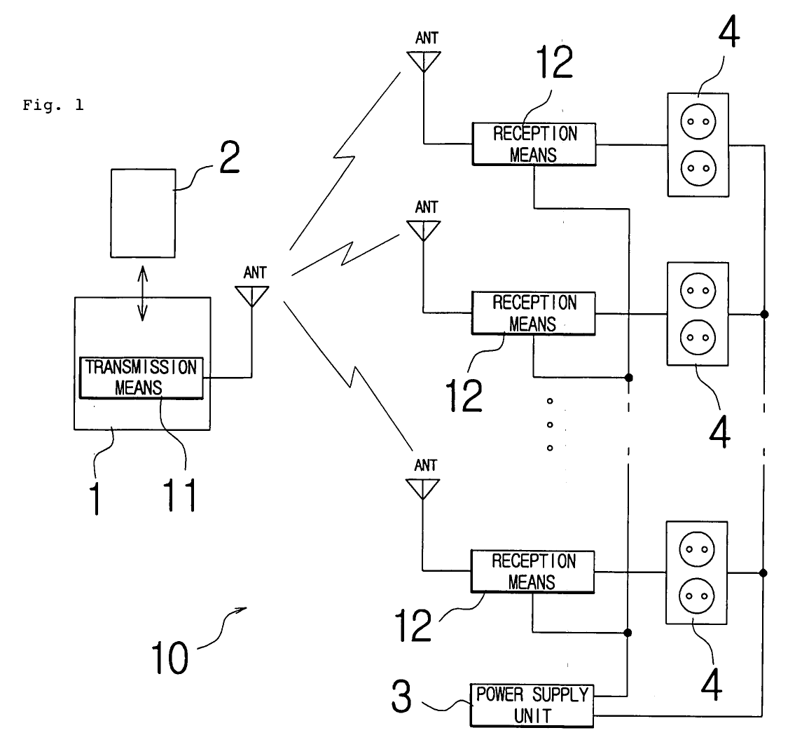

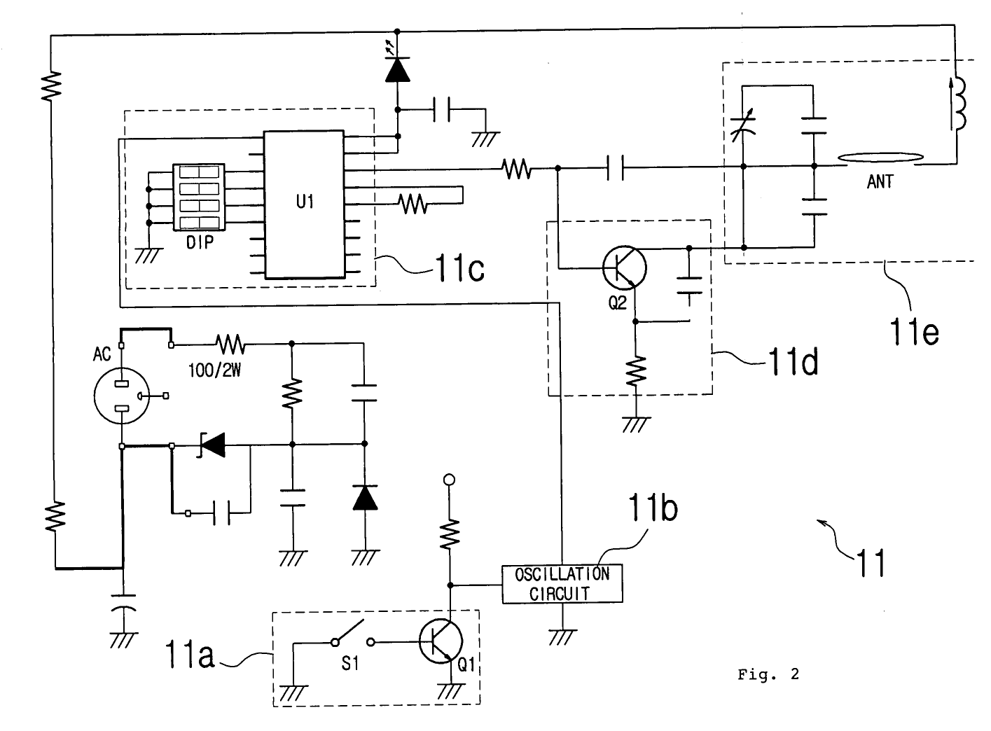

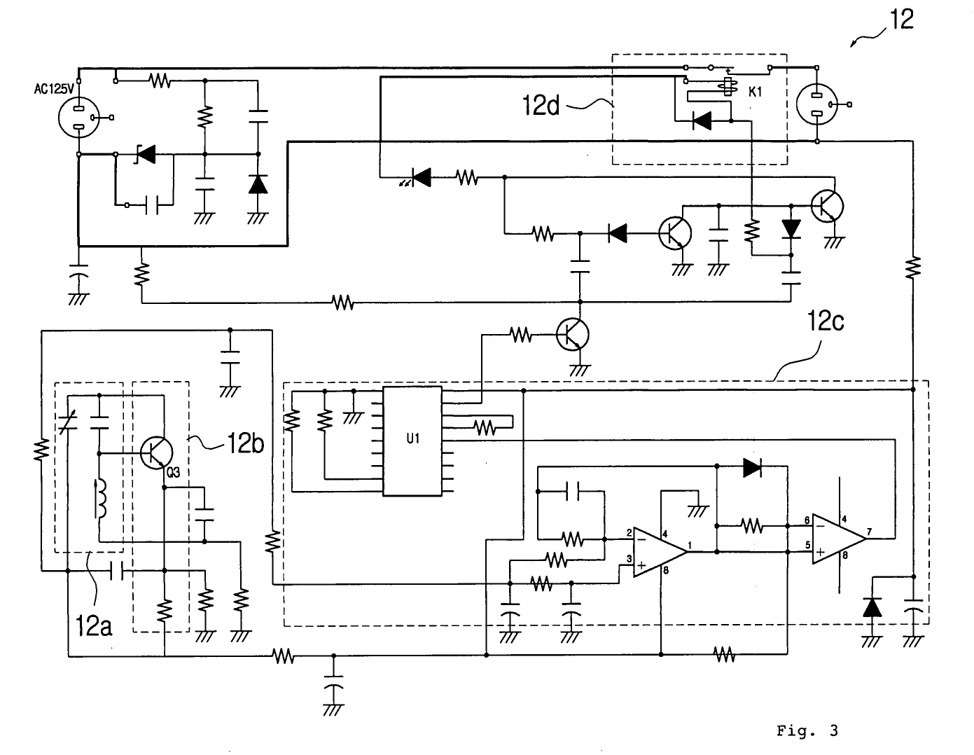

Before the present invention is described, the attached drawings, provided in order to understand the technique of the present invention, will be described. FIG. 1 is a block diagram and FIGS. 2 and 3 are circuit diagrams, which show configuration according to an embodiment of the present invention. Reference number 10 indicates a power on and off system according to the present invention.

The present invention will be described with reference to the attached drawings below.

First, as shown in FIG. 1, the present invention provides a power on and off system 10, which selectively supplies power of a power supply unit 3 and cuts off the supply of power between the power supply unit 3 and at least one electric outlet 4 depending on the insertion of a door card key 2 into a door card key receptacle 1 provided inside the door. The power on and off system 10 includes transmission means 11 mounted in the door card key receptacle 1, and configured to transmit a Radio Frequency (RF) signal depending on the insertion of the door card key 2; and at least one reception means 12 selectively mounted in the electric outlet 4 to which one or more electric devices are connected, and configured to receive the RF signal, transmitted from the transmission means 11 and then selectively supply power and cut off the supply of power to the electric outlet 4 through a switching operation.

Here, as shown in FIG. 2, the transmission means 11 of the present invention may include a switch unit 11a configured to be turned and off depending on the insertion of the door card key 2, a switch monitoring unit 11b configured to generate a clock signal depending on whether the switch unit 11a has been switched on or off, a microcomputer unit 11c configured to generate an RF signal based on a previously set address when the clock signal is generated by the switch monitoring unit 11b, a transmission signal amplification unit 11d configured to amplify the RF signal generated by the microcomputer unit 11c, and a transmission unit 11e configured to transmit the resulting RF signal amplified by the transmission signal amplification unit 11d.

Here, the switch unit 11a may be configured to include a limit switch S1, and a first transistor Q1 which is turned on and off based on the switching operation of the limit switch S1.

Further, the switch monitoring unit 11b may be an oscillation circuit for generating a clock signal when a signal is input based on operation of the switch unit 11a.

Further, the microcomputer unit 11c may be configured to include a Dual In-line Package (DIP) switch ‘DIP’ for preventing crosstalk with peripheral systems by setting an address through the manipulation of the switch, and a microprocessor U1 for operating based on the clock signal input from the switch monitoring unit 11b, and outputting an RF signal corresponding to the address set by the DIP switch ‘DIP’.

Further, the transmission signal amplification unit 11d may be an amplification circuit which includes a second transistor Q2 for amplifying the RF signal, output from the microcomputer unit 11C, to a level at which the RF signal can be transmitted.

Further, the transmission unit 11e may be a transmission circuit having an antenna and a resonance circuit, which is configured to tune a signal, output through the transmission signal amplification unit 11d, to a desired frequency and then output the tuned signal, and to include a coil and a capacitor.

Meanwhile, as shown in FIG. 3, the reception means 12 of the present invention may include a reception unit 12a configured to receive the RF signal transmitted from the transmission means 11, a reception signal amplification unit 12b configured to amplify the RF signal received from the reception unit 12a, a drive signal generation unit 12c configured to convert the RF signal, amplified by the reception signal amplification unit 12b, into a drive signal and then output the drive signal, and a control switch unit 12d configured to be turned on and off in response to the drive signal generated by the drive signal generation unit 12c.

Here, the reception means 12 may be molded and mounted on the rear surface inside the box of the electric outlet 4.

Here, the reception unit 12a may be a reception circuit having an antenna and a resonance circuit, which is configured to tune a signal, output from the transmission means 11, to a desired frequency and then input the tuned signal, and to include a coil and a capacitor.

Further, the reception signal amplification unit 12b may be an amplification circuit which is configured to include a third transistor Q3 for amplifying an RF signal attenuated in the transmission and reception process.

Further, the drive signal generation unit 12c may be a comparison circuit configured to include an Operation Amplifier (OP-AMP) for comparing the amplified RF signal with a reference signal, determining that the amplified RF signal is a normal signal only when the amplified RF signal falls within the range of the reference signal, and then outputting a drive signal.

Further, the control switch unit 12d may be a switching circuit configured to include a relay K1 for performing a switching operation when the drive signal is output from the drive signal generation unit 12c.

A power supply circuit converts Alternating Current (AC) power into Direct Current (DC) power, and then supplies the DC power to the transmission means 11 and the reception means 12 of the present invention.

In the present invention configured as described above, when the door card key 2 is inserted into the door card key receptacle 1 provided inside the door, the limit switch S1 of the switch unit 11a is turned on, and then turns on the first transistor Q1.

Therefore, power is supplied to the switch monitoring unit 11b, connected to the collector terminal of the first transistor Q1, so that a clock signal is generated from the oscillation circuit.

When the generated clock signal is input to the microprocessor U1 of the microcomputer unit 11c, the microprocessor U1 outputs an RF signal corresponding to an address previously set by operating the DIP switch ‘DIP’.

The output RF signal is amplified to a level, at which the RF signal can be transmitted, by the transmission signal amplification unit 11d, and the amplified RF signal is transmitted at a desired frequency (which is previously set) through the resonance circuit and antenna of the transmission unit 11e.

When the RF signal is transmitted, the antenna of the reception means 12 collects the RF signal. The collected RF signal is input to the reception unit 12a through the resonance circuit configured to include a coil and a capacitor and to constitute the reception unit 12a.

The input RF signal is amplified by the reception signal amplification unit 12b to a level, at which the RF signal can be processed, the RF signal being attenuated in the transmission and reception process.

Thereafter, the OP-AMP, which constitutes the drive signal generation unit 12c, compares the amplified RF signal with a reference signal, determines that the RF signal is a normal signal only when the RF signal falls within the range of the reference signal, and then outputs a drive signal.

When the drive signal is output, the relay K1, which constitutes the control switch unit 12d, operates and connects the wire of the electric outlet 4 so that power is supplied thereto.

Here, if the door card key 2, inserted into the door card key receptacle 1 provided inside the door, is drawn out therefrom, the limit switch S1 of the switch unit 11a is turned off, and turns off the first transistor Q1.

Accordingly, the supply of power to the switch monitoring unit 11b is cut off, with the result that the above-described operations are not performed, so that the wire of the electric outlet 4 is electrically cut off.

The operation of the present invention is performed in the state in which all the electric devices, other than one or more electric devices, such as a refrigerator, which require power to be always supplied, are inserted into respective electric outlets 4.

As described above, the present invention can selectively and automatically turn on and off electric devices via wireless transmission/reception based on entering and leaving a predetermined region (for example, a hotel or a household) in which the door card key 2 is used.

That is, the present invention can automatically turn on and off the power of electric devices, other than one or more electric devices, such as a refrigerator, which require power to be always supplied, based on entering and leaving.

The present invention can automatically and selectively turn on and off electric devices via wireless transmission/reception based on entering and leaving a predetermined region in which a door card key is used. That is, the present invention has an advantage in that the power of electric devices, other than one or more electric devices, such as a refrigerator, which require power to be always supplied, is automatically turned on and off, thereby saving energy and preventing a fire.

Further, when a user is not in a predetermined region, the power to electric devices is turned off and the turned-off state is maintained, thereby saving energy and preventing a fire.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Therefore, appropriative modifications and variations of the equivalent elements of the present invention should be included in the range of the present invention.

What is claimed is:

1. A system for turning on and off power using a door card key, the system selectively supplying power and cutting off supply of power between a power supply unit and at least one electric outlet depending on insertion of a door card key into a door card key receptacle inside a door, the system comprising:
transmission means mounted in the door card key receptacle, and configured to transmit a Radio Frequency (RF) signal depending on the insertion of the door card key; and
at least one reception means selectively mounted in the electric outlet to which at least one electric device is connected, and configured to receive the RF signal from the transmission means and then selectively supply power and cut off supply of power to the electric outlet through a switching operation;
wherein the transmission means comprises a switch unit configured to be turned on and off depending on the insertion of the door card key, a switch monitoring unit configured to generate a clock signal depending on whether the switch unit is turned on or off, a microcomputer unit configured to generate an RF signal based on a previously set address when the clock signal is generated by the switch monitoring unit, a transmission signal amplification unit configured to amplify the RF signal generated by the microcomputer unit, and a transmission unit configured to transmit the RF signal amplified by the transmission signal amplification unit; and
wherein the reception means comprises a reception unit configured to receive the RF signal from the transmission means, a reception signal amplification unit configured to amplify the RF signal from the reception unit, a drive signal generation unit configured to convert the RF signal, amplified by the reception signal amplification unit, into a drive signal and then output the resulting drive signal, and a control switch unit configured to be turned on and off in response to the drive signal generated by the drive signal generation unit.
